(19) United States
(12) Patent Application Publication
(10) Pub. No.: US 2007/0268356 A1
(43) Pub. Date: Nov. 22, 2007

(54) Information recording apparatus for thermosensitive medium

(76) Inventors: Kazunori Murakami, Izunokuni-shi (JP); Yoshimitsu Ohtaka, Sunto-gun (JP); Toshiyuki Tamura, Mishima-shi (JP); Takayuki Hiyoshi, Sunto-gun (JP)

Correspondence Address: HARNESS, DICKEY & PIERCE, P.L.C., P.O. BOX 828, BLOOMFIELD HILLS, MI, 48303, US

(21) Appl. No.: 11/804,407

(22) Filed: May 17, 2007

(30) Foreign Application Priority Data
May 19, 2006 (JP) 2006-140367
Mar. 13, 2007 (JP) 2007-062848

(51) Int. Cl. B41J 2/455

(52) U.S. Cl. 347/233

(57) ABSTRACT

A recording apparatus for recording information in a thermosensitive medium which has a photothermal conversion layer having a light wavelength absorption property and a coloring layer colored by the heat generated by the photothermal conversion layer comprises a first light source that emits a light beam for writing information to a scanning position in a main scanning direction in the thermosensitive medium, and a second light source that emits a light of lower energy density than the light beam emitted by the first light source to the scanning position in the main scanning direction in the thermosensitive medium or to the vicinity thereof. The first light source and the second light source emit lights having wavelengths within the range of the absorption property of the photothermal conversion layer respectively to form recording dots of one line in the main scanning direction in a noncontact manner with the thermosensitive medium.

### CROSS-REFERENCE TO RELATED APPLICATIONS

This application is based upon and claims the benefit of priority from prior Japanese Patent Applications No. 2006-140367, filed May 19, 2006; and No. 2007-062848, filed Mar. 13, 2007, the entire contents of both of which are incorporated herein by reference.

### BACKGROUND OF THE INVENTION

1. Field of the Invention

The present invention relates to an apparatus for recording information in a thermosensitive medium by a combination of dots.

2. Description of the Related Art

Thermosensitive media include a recording medium capable of thermal recording and a rewritable medium capable of thermal recording and thermal erasing. Conventionally, for recording media, there are known recording apparatuses using thermosensitive materials such as leuco dye systems and diazo compound systems. Conventionally, for a rewritable medium, there are known recording apparatuses using reversible thermal recording materials capable of repeating coloring and decoloring at a predetermined temperature. These recording apparatuses record information by heating a thermosensitive medium by means of a thermal head to color it. For a rewritable medium, the heating temperature is further changed to decolor the medium and erase the record. The thermal head comes into contact with the thermosensitive medium.

In Jpn. Pat. Appln. Publication No. 5-147378, there is disclosed a recording method for coloring and decoloring a rewritable medium in a noncontact manner. In the method, there is used an information recording medium in which an infra-red absorption exothermic layer and a thermal recording layer are sequentially laminated on a substrate. The recording apparatus makes the infra-red absorption exothermic layer generate heat by irradiating infra-red laser to the information recording medium. When the infra-red absorption exothermic layer generates heat, the heat colors the thermal recording layer thereby to record information in the information recording medium.

However, in order to color a rewritable medium by means of laser in a noncontact manner, a high output laser is required. A compact and relatively cheap semiconductor laser having an output on the order of several watts cannot deal therewith unless any idea such as a decreased scanning speed is employed. Therefore, a recording speed obtained in using a line-type thermal head cannot be realized. There is also a method in which a high output laser such as a YAG laser having an output of several tens watts is used. However, in this method, there is a problem that an expensive and large-sized recording apparatus must be used.

### BRIEF SUMMARY OF THE INVENTION

An object of the present invention is to provide an economically more efficient and down-sized information recording apparatus capable of realizing a sufficient recording speed by using a relatively low output light source.

According to one aspect of the present invention, a recording apparatus for recording information in a thermosensitive medium which has a photothermal conversion layer having a light wavelength absorption property and a coloring layer colored by the heat generated by the photothermal conversion layer comprises: a first light source that emits a light beam for writing information to a scanning position in a main scanning direction in the thermosensitive medium; and a second light source that emits a light of lower energy density than the light beam emitted by the first light source to the scanning position in the main scanning direction in the thermosensitive medium or to the vicinity thereof. The first and second light sources emit lights having wavelengths within the range of the absorption property of the photothermal conversion layer respectively to form recording dots of one line in the main scanning direction in a noncontact manner with the thermosensitive medium.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and comprise a part of the specification, illustrate embodiments of the invention, and together with the general description given above and the detailed description of the embodiments given below, serve to explain the principles of the invention.

FIG. 1 is a perspective view showing a main section configuration of a recording apparatus according to a first embodiment of the present invention;

FIG. 2 is a side view showing a positional relationship among a laser emission section, an LED emission section and a thermosensitive medium in the first embodiment;

FIG. 3 is a block diagram showing a configuration of a control section in the first embodiment;

FIG. 4 is a graph showing a relationship among the wavelength of a laser beamlaser beam from the laser emission section, the wavelength of an LED light beam from the LED emission section and the absorption wavelength property of the photothermal conversion layer of the thermosensitive medium in the first embodiment;

FIG. 5 is a view showing a positional relationship of the irradiations of the laser beamlaser beam and the LED light beam to the thermosensitive medium in the first embodiment;

FIG. 6 is a view showing the operational timings of the laser emission section and the LED emission section in the first embodiment;

FIG. 7 is a graph showing the property of the temperature rise of the photothermal conversion layer caused by the LED light beam and the laser beamlaser beam in the first embodiment;

FIG. 8 is a view showing a variation example of the positional relationship of the irradiations of the laser beam and the LED light beam to the thermosensitive medium in the first embodiment;

FIG. 9 is a view showing the operational timings of the laser emission section and the LED emission section in a variation example of the first embodiment;

FIG. 10 is a perspective view showing a main section configuration of a recording apparatus according to a second embodiment of the present invention;

FIG. 11 is a view showing a positional relationship of the irradiations of the laser beams and the LED light beams to the thermosensitive medium in the second embodiment;

FIG. 12 is a view showing a variation example of the positional relationship of the irradiations of the laser beams and the LED light beams to the thermosensitive medium in the second embodiment;

FIG. 13 is a view showing another variation example of the positional relationship of the irradiations of the laser beams and the LED light beams to the thermosensitive medium in the second embodiment;

FIG. 14 is a graph showing a variation example of the relationship among the wavelengths of laser beams from the laser emission sections, the wavelengths of LED light beams from the LED emission sections and the absorption wavelength property of the photothermal conversion layer of the thermosensitive medium in the first or second embodiment;

FIG. 15 is a graph showing a variation example of the relationship between the wavelengths of laser beams from the laser emission sections and LED light beams from the LED emission sections and the absorption wavelength property of the photothermal conversion layer of the thermosensitive medium in the first or second embodiment;

FIG. 16 is a view showing one configurational example in which a semiconductor laser is used as a second light source in the first or second embodiment; and

FIG. 17 is a view showing another configurational example in which a semiconductor laser is used as a second light source in the first or second embodiment.

### DETAILED DESCRIPTION OF THE INVENTION

Now, embodiments of the present invention will be described with reference to the accompanying drawings.

### First Embodiment

First, a first embodiment in which a pair of a laser emission section and an LED emission section is arranged will be described.

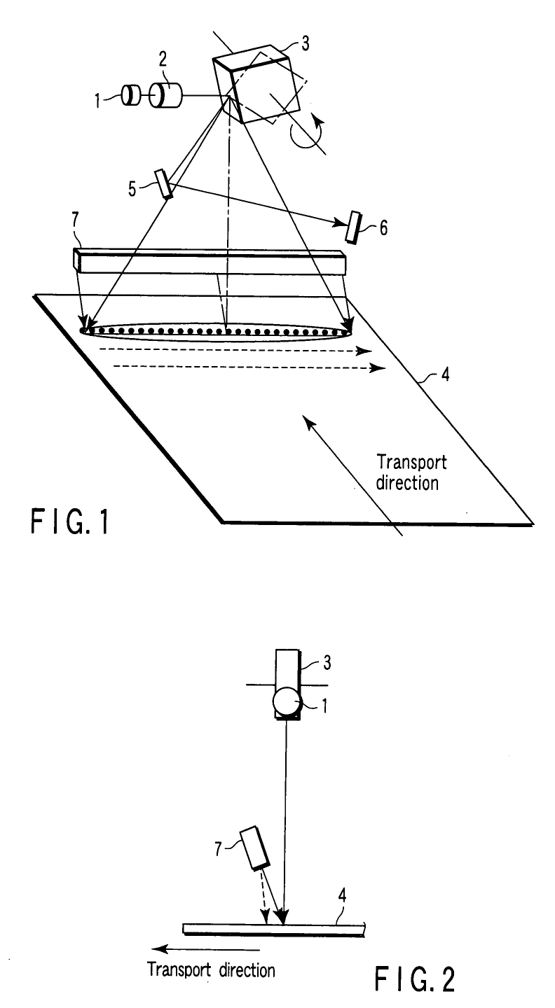

FIG. 1 is a perspective view showing a main section configuration of a recording apparatus according to the first embodiment of the present invention. The recording apparatus is provided with a laser emission section 1 as a first light source. A laser beam from the laser emission section 1 is irradiated via a collimator 2 to a polygon mirror 3. The laser emission section 1 is composed of a commercially available semiconductor laser of an output of several watts having an emission wavelength λ1 in the near-infrared (750 to 1,000 nm).

The collimator 2 converts the laser beam as the divergent light into parallel luminous fluxes. The laser emission section 1 has a high calorific power. Thus, the laser emission section 1 is fixed to a heat slinger so as to radiate generated heat.

The polygon mirror 3 is driven to rotate by a polygon motor described later.

The laser beam from the laser emission section 1 is converted into a light beam used for writing information. The light beam scans a thermosensitive medium 4 being transported in the direction of an arrow in the figure in a main scanning direction perpendicular to the transport direction (sub-scanning direction) by the rotations of the polygon mirror 3. The polygon mirror 3 is arranged so that the rotational axis thereof may be parallel to the sub-scanning direction as the transport direction of the thermosensitive medium 4. In addition, if a folded mirror or a prism is used along the path, the rotational axis of the polygon mirror 3 may not be parallel to the sub-scanning direction due to the effect of a reflection surface angle.

For the laser beam emitted from the laser emission section 1 via the collimator 2 to the reflection surface of the polygon mirror 3, the center optical axis of the incoming light beam becomes perpendicular to the rotational axis of the polygon mirror 3. The laser beam reflected by the polygon mirror 3 is reflected as a light beam at a predetermined timing by a folded mirror 5 to come into a writing position sensor 6.

The recording apparatus is provided with an LED emission section 7 as a second light source in which a plurality of light-emitting diodes (LEDs) are arranged in the main scanning direction. The LED emission section 7 is arranged, as shown in FIG. 2, at a low position above the thermosensitive medium 4 so that the lights from the respective LEDs may be irradiated directly to the thermosensitive medium 4. The lights from the respective LEDs of the LED emission section 7 have a lower energy density compared to the laser beam from the laser emission section 1. The LED emission section 7 irradiates the lights from the respective LEDs with being spread line-like in the main scanning direction. The wavelength λ2 of the lights from the respective LEDs is substantially same as the wavelength λ1 of the laser beam from the laser emission section 1.

In FIG. 2, an irradiation light beam from the LED emission section 7 is indicated by a full line arrow and a dotted line arrow. The full line arrow indicates a case where the irradiation light beam is superimposed on the scanning line of the laser beam. The dotted line arrow indicates a case where the irradiation light beam is irradiated to the vicinity of the scanning line of the laser beam.

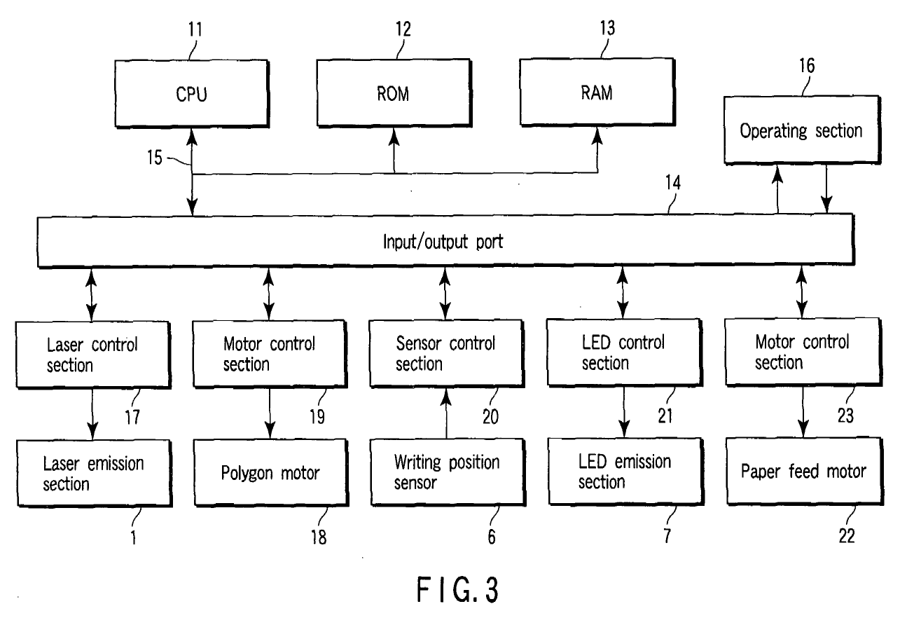

FIG. 3 is a block diagram showing a configuration of a control section of the recording apparatus. The control section comprises a CPU 11, a ROM 12, a RAM 13 and an input/output port 14. The CPU 11 is electrically connected to the ROM 12, RAM 13 and the input/output port 14 by a bus line 15.

The CPU 11 composes a main unit of the control section. In the ROM 12, there is stored a program required for the CPU 11 to control the various components of the recording apparatus. In the RAM 13, there are provided a memory area used for performing operations and data processing and a memory area used for temporarily storing data. The input/output port 14 controls the inputs and outputs to/from the various components connected externally.

An operating section 16, a laser control section 17, a motor control section 19, a sensor control section 20, an LED control section 21 and a motor control section 23 are connected to the input/output port 14. A keyboard and a display are arranged in the operating section 16. The laser control section 17 controls the laser emission section 1. The motor control section 19 controls a polygon motor 18. The polygon mirror 3 is driven to rotate by the polygon motor 18. The sensor control section 20 controls the writing position sensor 6. The LED control section 21 controls the LED emission section 7. The motor control section 23 controls a paper feed motor 22. The thermosensitive medium 4 is transported by the paper feed motor 22.

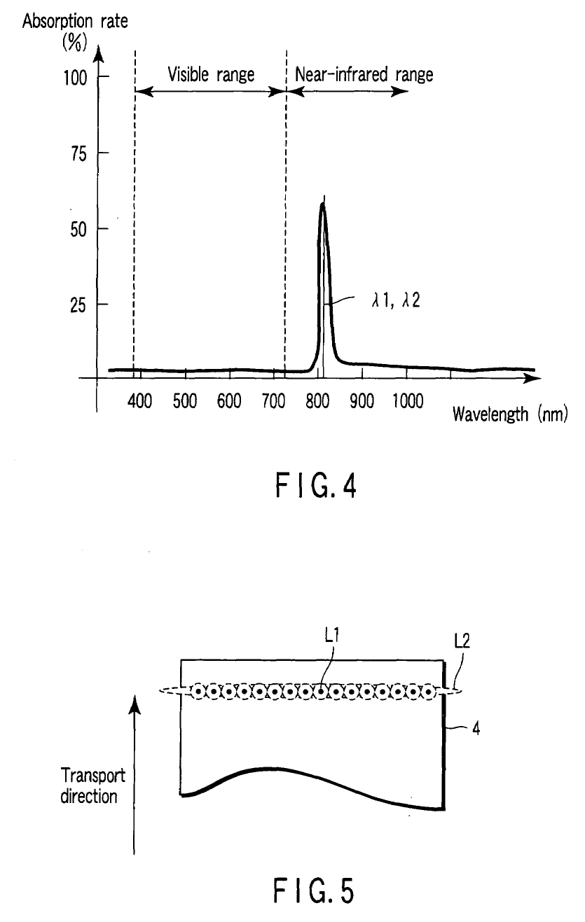

The thermosensitive medium 4 uses a rewritable medium which has a photothermal conversion layer having a light wavelength absorption property and a coloring layer colored and decolored by the heat generated by the photothermal conversion layer. The absorption property of the photothermal conversion layer accords, as shown in FIG. 4, at the peak position thereof with the wavelength λ1 of the laser beam from the laser emission section 1 and the wavelength λ2 of the LED light beam from the LED emission section 7. As such a rewritable medium, there is known, for example, a TR-116 (made by Mitsubishi Paper Mills Limited).

It depends on the heat generation temperature of the photothermal conversion layer whether the coloring layer is colored or decolored. According to the present embodiment, in a state in which information is written in the thermosensitive medium 4 by coloring the coloring layer, for example, when the laser emission section 1 of the first light source is stopped and the output of the LED emission section 7 as the second light source is slightly raised, the coloring layer is decolored thereby to erase information.

For the thermosensitive medium 4, the absorption property of the photothermal conversion layer accords at the peak position thereof with the wavelength λ1 of the laser beam from the laser emission section 1, enabling the efficiency of the photothermal conversion by the photothermal conversion layer to be improved. Moreover, since the peak position of the absorption property of the photothermal conversion layer lies outside an optical wavelength, the thermosensitive medium 4 is seldom heat-sensitized to usual illuminations. Therefore, the thermosensitive medium 4 can be prevented from being deteriorated.

In such a configuration, the laser beam L1 from the laser emission section 1 scans the thermosensitive medium 4 being transported in the main scanning direction by the rotations of the polygon mirror 3. By this scanning, as shown in FIG. 5, dots of one line are recorded in the thermosensitive medium 4. At this time, the respective LEDs of the LED emission section 7 are lighted sequentially just before the scanning by the laser beam L1 in the main scanning direction. By these lightings, the LED light beam L2 from the LED emission section 7 is irradiated so as to be superimposed onto the scanning line of the laser beam L1.

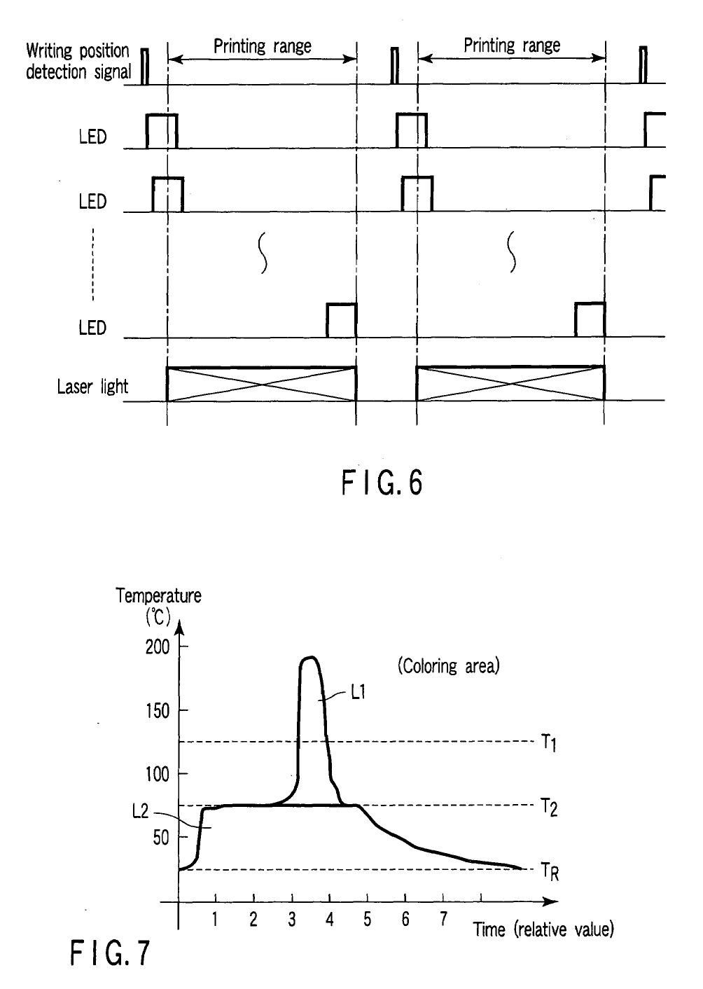

By irradiating with the LED light beam L2, the scanning range of the laser beam L1 is heated. The laser beam L1 scans this heated line-like range virtually simultaneously. The operating timings of the laser emission section 1 and the LED emission section 7 at this time are shown in FIG. 6.

First, a writing position detection signal is output from the writing position sensor 6. Subsequently, the respective LEDs of the LED emission section 7 emit lights sequentially for a certain period of time to sequentially preheat the scanning line of the laser beam. The laser beam from the laser emission section 1 turns the laser beam on or off in the printing range based on the bit data of “1” or “0” in the recorded information. This laser beam is turned on or off with chasing the preheated portions by the respective LED light beams for scanning. When the laser beam is turned on, the laser beam L1 is irradiated to the photothermal conversion layer.

In this operation, the photothermal conversion layer of the thermosensitive medium 4 is, as shown in FIG. 7, preheated from a room temperature TR to a temperature T2 by the LED light beam L2 from the LED emission section 7. The photothermal conversion layer is rapidly heated by the irradiation of the laser beam L1 from the laser emission section L1 and reaches a temperature higher than a temperature T1. Then, the photothermal conversion layer is immediately cooled rapidly and reaches a temperature lower than the temperature T1. In a temperature range above the temperature T1, the thermosensitive medium 4 is colored. By this coloring, dots are recorded. The rapid cooling after the rapid heating prevents decoloring. If the thermosensitive medium 4 is gradually cooled, the colored coloring layer meets the condition of decoloring thereby to be decolored.

As described above, after preheated to the temperature T2 by the LED light beam L2 from the LED emission section 7, the thermosensitive medium 4 is heated by the laser beam L1 from the laser emission section 1 thereby to be colored. Accordingly, the laser emission section 1 need not have a high output, and a commercially available semiconductor laser having an output on the order of several watts may be used. In addition, the irradiation time of the laser beam L1 required for recording dots can be shortened sufficiently.

Accordingly, an economically more efficient and down-sized recording apparatus can be provided. In addition, the same printing speed as that of a line thermal head heating one line simultaneously to make prints can be ensured to realize a sufficient recording speed. Moreover, in contrast to the line thermal head, no information is recorded by coming into contact with the thermosensitive medium 4, being very advantageous to a rewritable medium in which the thermosensitive medium 4 repeats recording and erasing many times.

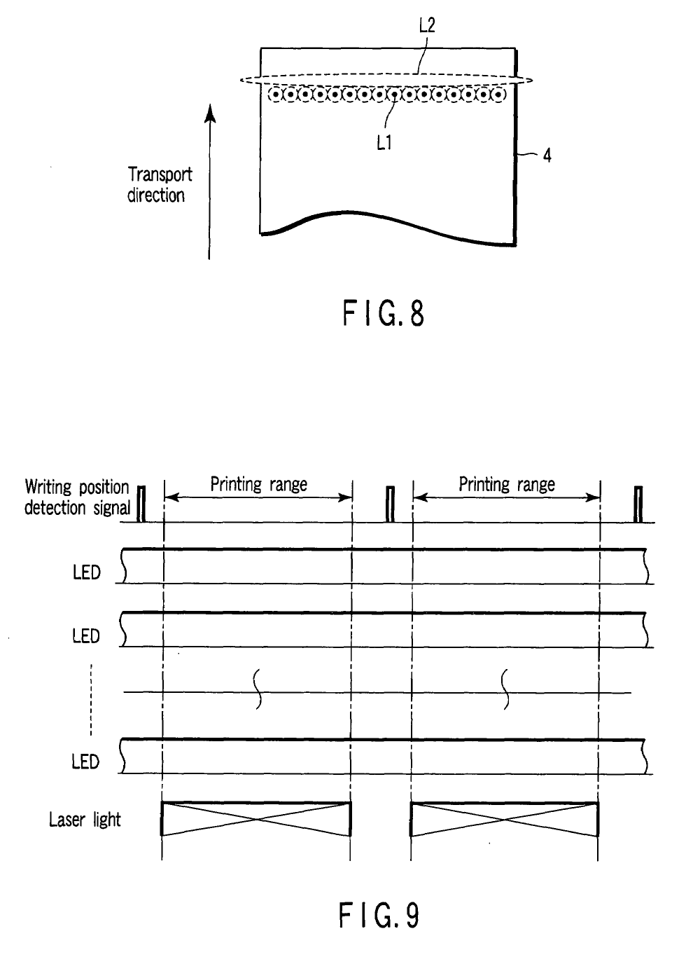

In the first embodiment, the recording operation of the thermosensitive medium 4 is not limited to the above. For example, as shown in FIG. 8, the LED light beam L2 from the LED emission section 7 may preheat the vicinity of the scanning line and subsequently the laser beam L1 may be irradiated to the scanning line to rapidly heat it. The operating timings of the laser emission section 1 and the LED emission section 7 at this time are shown in FIG. 9.

First, all the LEDs of the LED emission section 7 emit lights to preheat the vicinity of the scanning line of the laser beam. Next, a writing position detection signal is output from the writing position sensor 6. Subsequently, the laser beam L1 from the laser emission section 1 scans the scanning line. Then, the laser beam is turned on or off in the printing range based on the bit data of “1” or “0” in the recorded information. When the laser beam is turned on, dots are recorded.

As described above, also by controlling the laser emission section 1 and the LED emission section 7, similar effects and advantages can be obtained.

### Second Embodiment

Now, a second embodiment in which a plurality of pairs of laser emission sections and LED emission sections are arranged will be described.

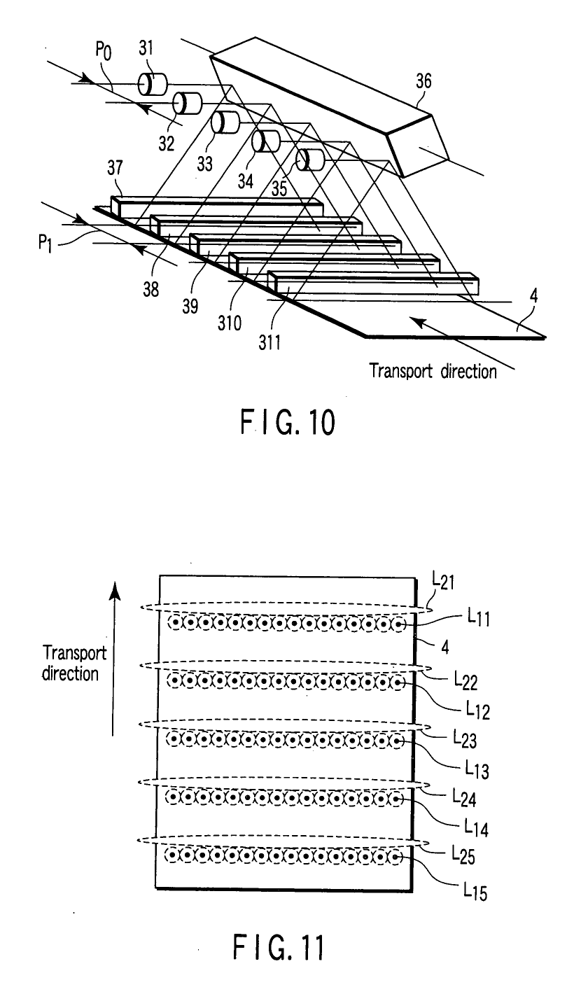

FIG. 10 is a perspective view showing a main section configuration of a recording apparatus in a second embodiment of the present invention. In the recording apparatus, there are arranged, as a first light source, five laser emission sections 31, 32, 33, 34 and 35 with a predetermined pitch P0 in the transport direction of the thermosensitive medium 4, each of the laser emission sections 31, 32, 33, 34 and 35 having a semiconductor laser and a collimator. The semiconductor laser is a commercially available one of an output of several watts having an emission wavelength in the near-infrared (750 to 1000 nm). The laser beams from the respective laser emission sections 31 to 35 are irradiated to the polygon mirror 36.

The arrangement pitch P0 of the respective laser emission sections 31 to 35 is a printing pitch P1 as it is in the transport direction of the thermosensitive medium 4, that is, in the sub-scanning direction. In addition, the printing pitch can be changed by using an optical fiber bundle or by changing the angle of the reflection surface of the polygon mirror.

The respective laser emission sections 31 to 35 have a high calorific power. Thus, the respective laser emission sections 31 to 35 are fixed to a heat slinger so as to radiate generated heat.

The polygon mirror 36 has a rotational axis and a long reflection surface parallel to the sub-scanning direction as the transport direction of the thermosensitive medium 4. The polygon mirror 36 is driven to rotate by a polygon motor. In addition, if a folded mirror or a prism is used along the path, the rotational axis of the polygon mirror 3 may not be parallel to the sub-scanning direction due to the effect of a reflection surface angle.

The laser beams from the respective laser emission sections 31 to 35 are reflected by the same reflection surface of the polygon mirror 36. For the laser beams emitted from the respective laser emission sections 31 to 35 to the reflection surface of the polygon mirror 36, the center optical axes of the incoming light beams become perpendicular to the rotational axis of the polygon mirror 36.

In the recording apparatus, there are provided, as a second light source, five LED emission sections 37, 38, 39, 310 and 311 in each of which a plurality of light-emitting diodes (LEDs) are arranged. The respective LED emission sections 37, 38, 39, 310 and 311 are arranged with a predetermined pitch in the transport direction of the thermosensitive medium 4, corresponding to the respective laser emission sections 31 to 35.

The respective LED emission sections 37 to 311 are arranged at a low position above the thermosensitive medium 4 so that the lights from the respective LEDs may be irradiated directly to the thermosensitive medium 4. The respective LED emission sections 37 to 311 irradiate the lights to be irradiated so that the lights to be irradiated may be superimposed on the laser beams from the respective laser emission sections 31 to 35 on the scanning lines. Alternatively, the respective LED emission sections 37 to 311 irradiate the lights to be irradiated to the vicinity of the scanning lines of the laser beams prior to the scanning lines of the laser beams.

In FIG. 11, there is shown a positional relationship of the irradiations of the laser beams and the LED light beams when the lights to be irradiated from the LED emission sections 37 to 311 are irradiated to the vicinity of the scanning lines of the laser beams. As shown in FIG. 11, a irradiation light beams L21, L22, L23, L24 and L25 from the respective LED emission sections 37 to 311 are irradiated continuously to the vicinity of the near side on the scanning lines of the laser beams L11, L12, L13, L14 and L15 from the respective laser emission sections 31 to 35. The area on scanning lines is preheated by the irradiation light beams L21, L22, L23, L24 and L25. Subsequently, when the area on the scanning lines is scanned by the laser beams L11, L12, L13, L14 and L15, the coloring layer is colored by a rapid heating thereby to record dots.

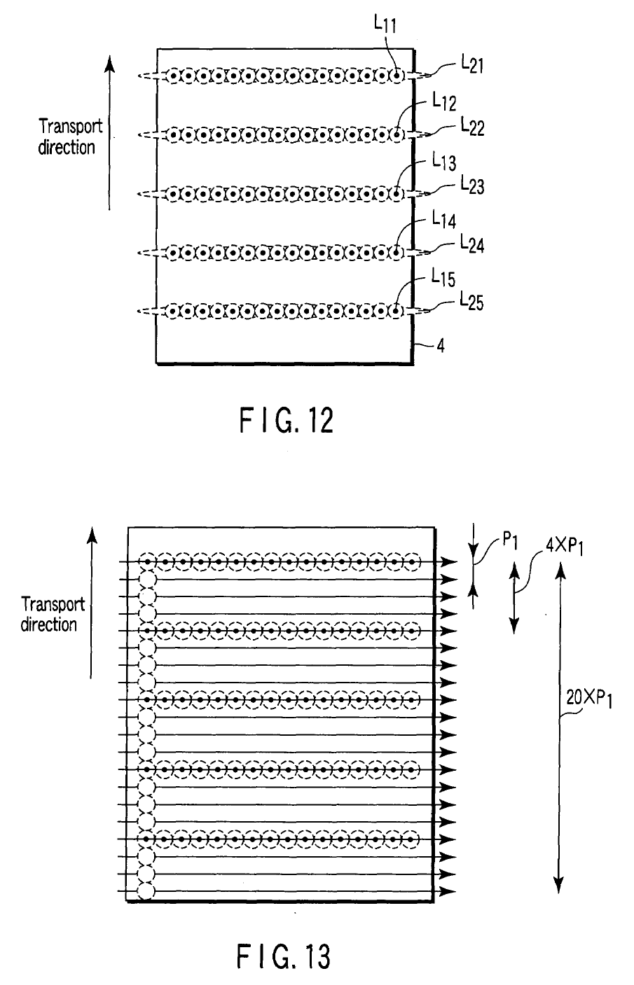

In FIG. 12, there is shown a positional relationship of the irradiations of the laser beams and the LED light beams when the lights to be irradiated from the LED emission sections 37 to 311 are irradiated virtually simultaneously to the scanning lines of the laser beams. As shown in FIG. 12, the irradiation light beams L21, L22, L23, L24 and L25 from the respective LED emission sections 37 to 311 are irradiated virtually simultaneously when the area on the scanning lines is scanned by the laser beams L1, L12, L13, L14 and L15 from the respective laser emission sections 31 to 35. That is, dots are recorded by the preheating by the irradiation light beams L21, L22, L23, L24 and L25 and by the scanning by the laser beams L11, L12, L13, L14 and L15.

In the recording apparatus, the arrangement pitch P0 of the respective laser emission sections 31 to 35 is a printing pitch P1 as it is in the sub-scanning direction of the thermosensitive medium 4. Thus, dots can be recorded simultaneously by five lines in the thermosensitive medium 4 in the main scanning direction thereof. When the scanning of one line is completed, the thermosensitive medium 4 is transported by a distance five times as large as the printing pitch P1. Moreover, after transportation, one line is scanned again by the respective laser emission sections 31 to 35 thereby to record dots. By repeating this, high-speed printing can be performed on the thermosensitive medium 4.

In the recording apparatus of the present embodiment, the arrangement pitch between the respective laser emission sections 31 to 35 may be set to four times as large as the printing pitch P1. In this case, as shown in FIG. 13, when the scanning of one line is completed, the thermosensitive medium 4 is transported by a distance of the printing pitch P1. Moreover, after transportation, one line is scanned again by the respective laser emission sections 31 to 35 thereby to record dots. The recording apparatus repeats this operation on four lines. If the thermosensitive medium 4 is short and the printing range in the sub-scanning direction is twenty times as large as the printing pitch P1, the printing on the thermosensitive medium 4 is completed by repeating this operation on four lines.

On the other hand, if the thermosensitive medium 4 is longer than twenty times of the printing pitch P1, the thermosensitive medium 4 is transported by a distance twenty times as large as the printing pitch P1 to record dots of four lines with a pitch four times as large as the printing pitch P1 by the respective laser emission sections 31 to 35. In this manner, printing can be performed simultaneously on five lines, thereby realizing high-speed printing.

As described above, also in the second embodiment, the recording apparatus can realize a sufficient recording speed. Moreover, the thermosensitive medium 4 is preheated by the LED light beams and is rapidly heated and cooled by the laser beams, thereby ensuring a reliable recording even if the laser emission section 1 has a relatively low output. Accordingly, an economically more efficient and down-sized recording apparatus can be provided.

In the second embodiment, five laser emission sections and five LED emission sections are arranged, and however, the number of the laser and LED emission sections is not limited to the above number.

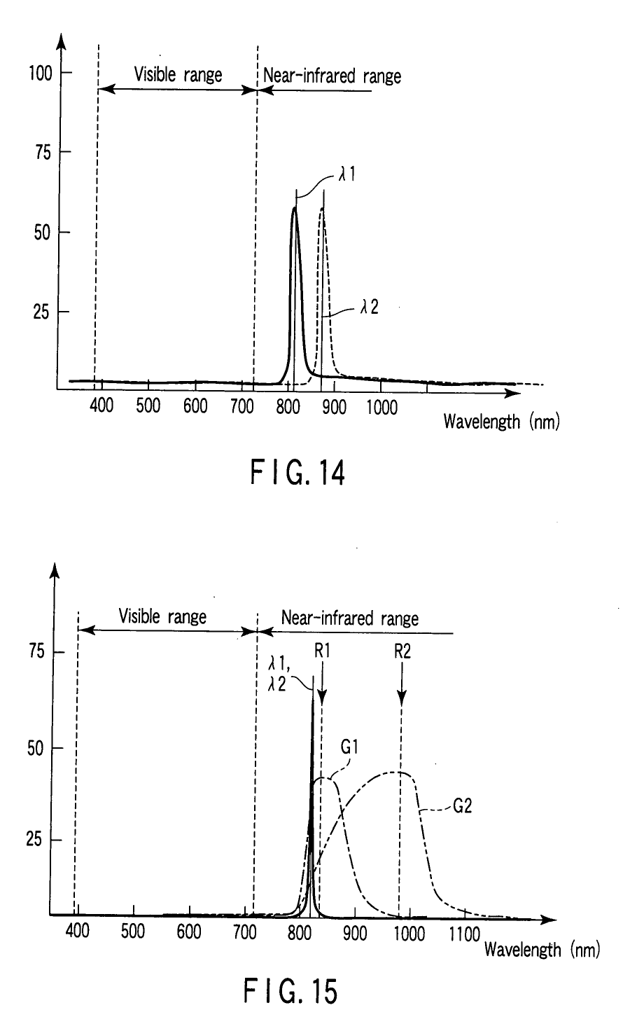

In the first and second embodiments, the wavelength λ1 of the laser beam from the laser emission section and the wavelength λ2 of the lights from the LED emission section are set substantially equal to each other, and however, the wavelength λ1 and the wavelength λ2 may be different from each other. For example, as shown in FIG. 14, when the wavelength λ1 and the wavelength λ2 are different from each other, a rewritable medium having a photothermal conversion layer with two absorption peaks is used so that the peak positions of the absorption property may accord with the respective wavelengths λ1 and λ2. As a photothermal conversion layer in this case, there is used a rewritable medium having one photothermal conversion layer with two absorption peaks or having two photothermal conversion layers with mutually different absorption peaks respectively. Thereby, similar effects and advantages are obtained.

Moreover, a rewritable medium having a photothermal conversion layer of which peak positions of the absorption property accord with the wavelengths λ1 and λ2 need not be necessarily used. The absorption property of the photothermal conversion layer exhibits, as shown in the curve G1 and the curve G2 of FIG. 15, unique curves depending on raw materials. For example, the absorption property indicated by the curve G1 has a peak at R1 and the absorption property indicated by the curve G2 has a peak at R2. By according the wavelengths λ1 and λ2 with the peak positions R1 and R2 of these absorption properties tentatively, photothermal conversion is performed most efficiently.

However, as shown in FIG. 15, if the wavelengths λ1 and λ2 exist in the ranges of the absorption property curve indicated by the curve G1 and the absorption property curve indicated by the curve G2, the photothermal conversion layer absorbs light thereby to perform photothermal conversion even though the efficiency is different depending on the absorption property. Accordingly, when a rewritable medium having a photothermal conversion layer with the absorption properties of these curves G1 and G2 is used, similar effects and advantages can be obtained.

In the first and second embodiments, a rewritable medium capable of coloring and decoloring is used as the thermosensitive medium, and however, a thermosensitive medium only for coloring may be used.

In the first and second embodiments, a semiconductor laser is used as the first light source, and however, the first light source is not limited thereto. Similarly, a LED is used as the second light source, and however, the second light source is not limited thereto. For example, a semiconductor laser may be used as the second light source.

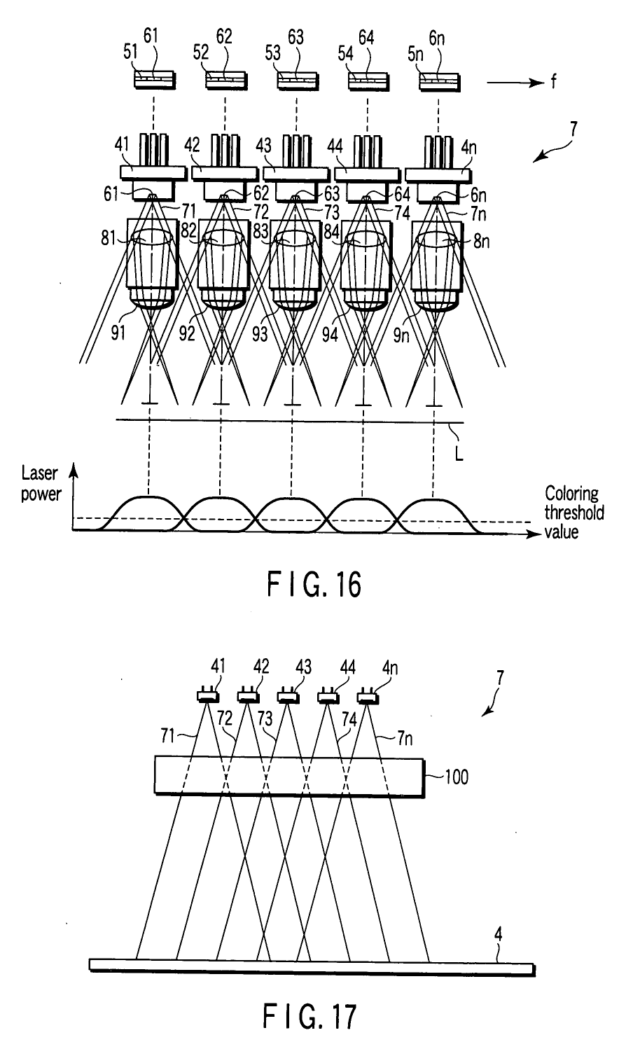

One configurational example in which semiconductor lasers are used as the second light source 7 is shown in FIG. 16. This second light source 7 includes a plurality of semiconductor lasers 41 to 4n. These semiconductor lasers 41 to 4n are of a high output multi-mode type. These semiconductor lasers 41 to 4n have laser emission areas 61 to 6n on the p-n bonding surfaces 51 to 5n of laminated structures respectively. In addition, the laser emission areas 61 to 6n formed on the p-n bonding surfaces 51 to 5n are shown above the semiconductor lasers 41 to 4n in FIG. 16, respectively.

The laser emission areas 61 to 6n of the semiconductor lasers 41 to 4n are longer in the direction of the p-n bonding surfaces 51 to 5n than the laser emission areas of a single-mode type semiconductor laser respectively. For example, the laser emission areas 61 to 6n are, for example, 50 to 200 μm long in the direction of the p-n bonding surfaces 51 to 5n in the multi-mode type semiconductor lasers 41 to 4n. This is, for example, by 3 μm longer than the laser emission areas 61 to 6n of a single-mode type semiconductor layer respectively. Thereby, the semiconductor laser beams 71 to 7n output from the multi-mode type semiconductor lasers 41 to 4n exhibit a property of being difficult to narrow down in the same direction as in the directions of the p-n bonding surfaces 51 to 5n when converted into images by optical axis object type lenses.

A plurality of collimator lenses (imaging lenses) 81 to 8n are provided on the optical path of the semiconductor laser beams 71 to 7n output from the semiconductor lasers 41 to 4n. The collimator lenses 81 to 8n exhibit a property of narrowing down the semiconductor laser beams 71 to 7n in a direction perpendicular to the directions f of the p-n bonding surfaces 51 to 5n and of being difficult to narrow down the semiconductor laser beams 71 to 7n in the same direction as in the directions f of the p-n bonding surfaces 51 to 5n. The semiconductors 41 to 4n are provided so that the directions f of the p-n bonding surfaces 51 to 5n may coincide with one another. In addition, actually the semiconductor lasers 41 to 4n are used as laser chips respectively.

The collimator lenses 81 to 8n convert the semiconductor laser beams 71 to 7n into images on the recording surface of the thermosensitive medium 4 respectively. These collimator lenses 81 to 8n are not anamorphic, but optical axis symmetrical.

A plurality of cylindrical lenses (anamorphic lenses) 91 to 9n as an intensity equalization optical system are provided on the optical path of the semiconductor laser beams 71 to 7n converted into images by the collimator lenses 81 to 8n respectively. These cylindrical lenses 91 to 9n are provided on the optical path of the semiconductor laser beams 71 to 7n output from semiconductor lasers 41 to 4n respectively. These cylindrical lenses 91 to 9n exert a refraction output in the arrangement directions of the semiconductor lasers 41 to 4n respectively. Nevertheless, these cylindrical lenses 91 to 9n superimpose parts of the semiconductor laser beams 71 to 7n converted into images on the recording surface of the thermosensitive medium 4 by the collimator lenses 81 to 8n, that is, the end portions of the semiconductor laser beams 71 to 7n in the same direction as the directions f of the p-n bonding surfaces 51 to 5n on one another, respectively, thereby defocusing the semiconductor laser beams 71 to 7n in the directions f of the p-n bonding surfaces 51 to 5n to equalize the intensity distribution on the recording surface of the thermosensitive medium 4 by the semiconductor laser beams 71 to 7n in the directions f of the p-n bonding surfaces 51 to 5n in the semiconductor lasers 41 to 4n, in other words, in the arrangement directions of the semiconductor lasers 41 to 4n.

Another configurational example in which semiconductor lasers are used as the second light source 7 is shown in FIG. 17. In this second light source 7 there is provided an anamorphic cylindrical lens (rod lens) 100 on the advancing optical path of the semiconductor laser beams 71 to 7n output from the semiconductor lasers 41 to 4n. This rod lens 100 superimposes parts of the semiconductor laser beams 71 to 7n output from the semiconductor lasers 41 to 4n on one another on the recording surface of the thermosensitive medium 4 to equalize the intensity distribution on the recording surface of the thermosensitive medium 4 by the semiconductor laser beams 71 to 7n in the arrangement directions of the semiconductor lasers 41 to 4n.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information recording apparatus for recording information in a thermosensitive medium which has a photothermal conversion layer having a light wavelength absorption property and a coloring layer colored by the heat generated by the photothermal conversion layer, comprising:
a first light source that emits a light beam for writing the information to a scanning position in a main scanning direction in the thermosensitive medium; and
a second light source that emits a light of lower energy density than the light beam emitted by the first light source to the scanning position in the main scanning direction in the thermosensitive medium or to the vicinity thereof, wherein
the first and second light sources and emit lights having wavelengths within the range of the absorption property of the photothermal conversion layer respectively.

2. The information recording apparatus according to claim 1, further comprising:
a scanning optical system that scans the thermosensitive medium with a light beam emitted from the first light source in the main scanning direction.

3. The information recording apparatus according to claim 1, further comprising:
control sections that control the first light source and the second light source to emit lights according to the writing operation of information in the thermosensitive medium.

4. The information recording apparatus according to claim 1, wherein
the first light source and the second light source emit lights of wavelengths in accordance with the peak positions of the absorption property which the photothermal conversion layer exhibits, respectively.

5. The information recording apparatus according to claim 2, wherein
the first light source and the second light source emit lights of wavelengths in accordance with the peak positions of the absorption property which the photothermal conversion layer exhibits, respectively.

6. The information recording apparatus according to claim 3, wherein
the first light source and the second light source emit lights of wavelengths in accordance with the peak positions of the absorption property which the photothermal conversion layer exhibits, respectively.

7. The information recording apparatus according to claim 1, wherein
the thermosensitive medium has a photothermal conversion layer in which two different wavelengths have peaks in the absorption property respectively,
the first light source emits a light having a wavelength according to one peak position in the absorption property, and
the second light source emits a light having a wavelength according to the other peak position in the absorption property.

8. The information recording apparatus according to claim 2, wherein
the thermosensitive medium has a photothermal conversion layer in which two different wavelengths have peaks in the absorption property respectively,
the first light source emits a light having a wavelength according to one peak position in the absorption property, and
the second light source emits a light having a wavelength according to the other peak position in the absorption property.

9. The information recording apparatus according to claim 3, wherein
the thermosensitive medium has a photothermal conversion layer in which two different wavelengths have peaks in the absorption property respectively,
the first light source emits a light having a wavelength according to one peak position in the absorption property, and
the second light source emits a light having a wavelength according to the other peak position in the absorption property.

10. The information recording apparatus according to claim 1, wherein
the second light source irradiates a light with being spread in a line-like manner in the main scanning direction of the thermosensitive medium.

11. The information recording apparatus according to claim 2, wherein
the second light source irradiates a light directly to the thermosensitive medium with the light being spread in a line-like manner in the main scanning direction of the thermosensitive medium.

12. The information recording apparatus according to claim 2, wherein
a plurality of the first light sources and a plurality of the second light sources are used respectively, and a plurality of pairs of one of the first light sources and one of the second light sources are formed, and
the pairs of the first light sources and the second light sources are arranged respectively so that the scanning positions in the main scanning direction of the thermosensitive medium may be deviated from one another by a distance of an integral multiple of the dot pitch in a direction perpendicular to the main scanning direction.

13. The information recording apparatus according to claim 12, wherein
the plurality of the second light sources emit lights of lower energy density than the light beams emitted by the plurality of the first light sources, and
the pairs of the first light sources and the second light sources supply an unwritable level of energy to the scanning positions in the main scanning direction in the thermosensitive medium or to the vicinity thereof by the lights from the second light sources, and the light beams from the first light sources scan the scanning positions in the main scanning direction in the thermosensitive medium to write information.
